(19) United States
(12) Patent Application Publication
(10) Pub. No.: US 2018/0341018 A1
(43) Pub. Date: Nov. 29, 2018

(54) SYSTEM, METHOD, AND DEVICE FOR DETERMINING LOCATION OF IN-WATER OBJECT

(71) Applicant: HUAWEI TECHNOLOGIES CO., LTD., Shenzhen, Guangdong (CN)

(72) Inventors: Muyun QIN, Shenzhen (CN); Xin YU, Shenzhen (CN); Mengte ZHOU, Shanghai (CN)

(21) Appl. No.: 15/771,596

(22) PCT Filed: Oct. 20, 2016
(86) PCT No.: PCT/CN2016/102768

§ 371 Date: Apr. 27, 2018

(30) Foreign Application Priority Data
Oct. 30, 2015 (CN) 201510733460.X

(51) Int. Cl. G01S 15/06

(52) U.S. Cl. CPC G01S 15/06

(57) ABSTRACT

The present disclosure relates to a system for determining a location of an in-water object. The system includes a first wearable device and at least three sensors. Each sensor is placed in water, and is configured to emit an electrical signal. The first wearable device is located on a to-be-located object, the to-be-located object is placed in the water, and the first wearable device is configured to: separately determine received signal strength indicator RSSI values of received electrical signals emitted by the at least three sensors, determine a distance between the first wearable device and each sensor according to the determined RSSI value, determine a location of the first wearable device in the water according to a pre-measured location of each sensor and the determined distance between the first wearable device and each sensor, and use the location as a location of the to-be-located object in the water.

This application claims priority to Chinese Patent Application No. 201510733460.X, filed with the Chinese Patent Office on Oct. 30, 2015, and entitled “SYSTEM, METHOD, AND DEVICE FOR DETERMINING LOCATION OF IN-WATER OBJECT”, which is incorporated herein by reference in its entirety.

### TECHNICAL FIELD

Embodiments of the present invention relate to the field of sensing technologies, and in particular, to a system, method, and device for determining a location of an in-water object.

### BACKGROUND

In recent years, swimming-caused drowning incidents have increased and attracted more attention. To improve swimming safety and reduce accidents, how to accurately detect a location of a swimmer in water becomes an important subject of current research.

At present, a location of an in-water object is mainly determined by using a water depth detector. An existing water depth detector includes a sensor and a detecting host, and detects the location of the in-water object by using the GPS (Global Positioning System, Global Positioning System) or water pressure. However, because of relatively great environmental impact, this method for determining a location of an in-water object has relatively low reliability.

In conclusion, an existing method for determining a location of an in-water object has relatively low reliability.

### SUMMARY

Embodiments of the present invention provide a system, method, and device for determining a location of an in-water object, to resolve a prior-art problem that a method for determining a location of an in-water object has relatively low reliability.

According to a first aspect, a system for determining a location of an in-water object is provided, including a wearable device, at least three sensors, and a processor, where

the wearable device is located on a to-be-located object, the to-be-located object is placed in water, and the wearable device is configured to emit an electrical signal;

each sensor is placed in the water, and is configured to: determine a received signal strength indicator RSSI value of a received electrical signal emitted by the wearable device, and send the determined RSSI value to the processor; and

the processor is located on ground, and is configured to: determine, according to the RSSI value sent by each sensor, a distance between the sensor that sends the RSSI value and the wearable device, determine a location of the wearable device in the water according to a pre-measured location of each sensor and the determined distance between each sensor and the wearable device, and use the location as a location of the to-be-located object in the water.

With reference to the first aspect, in a first possible implementation of the first aspect, the wearable device emits an electrical signal at intervals of preset duration.

With reference to the first possible implementation of the first aspect, in a second possible implementation of the first aspect, the processor is further configured to:

determine a distance between the wearable device and a surface of the water according to the determined location of the wearable device in the water;

after determining that the distance between the wearable device and the surface of the water is greater than a preset drowning height, increase a quantity of consecutive set-to-1 drowning identifiers by 1; and

if determining that the quantity of consecutive set-to-1 drowning identifiers is greater than a preset quantity, emit an alarm signal used to inform that the to-be-located object is at a dangerous location.

With reference to the second possible implementation of the first aspect, in a third possible implementation of the first aspect, the to-be-located object is a user;

the wearable device is further configured to send user information of the user to the sensor;

the sensor is further configured to send the received user information to the processor; and

the processor is specifically configured to: if determining that quantities of consecutive set-to-1 drowning identifiers for at least two wearable devices are all greater than the preset quantity, determine an alarm signal transmission order for each of the at least two wearable devices according to user information emitted by each wearable device; and emit, for each wearable device, according to the alarm signal transmission order for each wearable device, an alarm signal used to inform that a to-be-located object is at a dangerous location.

According to a second aspect, a system for determining a location of an in-water object is provided, including a first wearable device and at least three sensors, where

each sensor is placed in water, and is configured to emit an electrical signal; and

the first wearable device is located on a to-be-located object, the to-be-located object is placed in the water, and the first wearable device is configured to: separately determine received signal strength indicator RSSI values of received electrical signals emitted by the at least three sensors, determine a distance between the first wearable device and each sensor according to the determined RSSI value, determine a location of the first wearable device in the water according to a pre-measured location of each sensor and the determined distance between the first wearable device and each sensor, and use the location as a location of the to-be-located object in the water.

With reference to the second aspect, in a first possible implementation of the second aspect, the sensor emits an electrical signal at intervals of preset duration.

With reference to the first possible implementation of the second aspect, in a second possible implementation of the second aspect, the first wearable device is further configured to:

determine a distance between the first wearable device and a surface of the water according to the determined location;

after determining that the distance between the first wearable device and the surface of the water is greater than a preset drowning height, increase a quantity of consecutive set-to-1 drowning identifiers by 1; and

if determining that the quantity of consecutive set-to-1 drowning identifiers is greater than a preset quantity, emit an alarm signal used to inform that the to-be-located object is at a dangerous location.

With reference to the second possible implementation of the second aspect, in a third possible implementation of the second aspect, the first wearable device is further configured to:

if determining that the quantity of consecutive set-to-1 drowning identifiers is not greater than the preset quantity, store a current drowning identifier as 1 in a preset database, and emit a prompt signal used to inform that the to-be-located object is at a potentially dangerous location.

With reference to the second aspect, the first possible implementation of the second aspect, the second possible implementation of the second aspect, or the third possible implementation of the second aspect, in a fourth possible implementation of the second aspect, the first wearable device is further configured to:

determine an RSSI value of a received electrical signal emitted by a second wearable device;

determine a distance between the first wearable device and the second wearable device according to the RSSI value of the received electrical signal emitted by the second wearable device; and

after determining that the distance between the first wearable device and the second wearable device is greater than a preset dangerous distance, emit a rescue prompt signal.

According to a third aspect, a method for determining a location of an in-water object is provided, including:

receiving, by a processor for any wearable device placed in water, received signal strength indicator RSSI values sent by at least three sensors, where the RSSI value is an RSSI value of an electrical signal that is emitted by the wearable device and received by the sensor, the wearable device is located on a to-be-located object, and the sensors are placed in the water;

determining, by the processor according to each received RSSI value, a distance between the wearable device and a sensor that sends the RSSI value; and

determining, by the processor, a location of the wearable device in the water according to a pre-measured location of each sensor and the determined distance between the wearable device and each sensor that sends the RSSI value, and using the location as a location of the to-be-located object in the water.

With reference to the third aspect, in a first possible implementation of the third aspect, the processor receives, at intervals of preset time, the RSSI values sent by the at least three sensors.

With reference to the first possible implementation of the third aspect, in a second possible implementation of the third aspect, after the processor determines the location, the method further includes:

determining, by the processor, a distance between the wearable device and a surface of the water according to the determined location;

after determining that the distance between the wearable device and the surface of the water is greater than a preset drowning height, increasing, by the processor, a quantity of consecutive set-to-1 drowning identifiers by 1; and

emitting, by the processor, if determining that the quantity of consecutive set-to-1 drowning identifiers is greater than a preset quantity, an alarm signal used to inform that the to-be-located object is at a dangerous location.

With reference to the second possible implementation of the third aspect, in a third possible implementation of the third aspect, the to-be-located object is a user;

the method further includes:

receiving, by the processor, user information of the user that is sent by the wearable device by using the sensor; and

the emitting, by the processor, if determining that the quantity of consecutive set-to-1 drowning identifiers is greater than a preset quantity, an alarm signal used to inform that the to-be-located object is at a dangerous location includes:

if determining that quantities of consecutive set-to-1 drowning identifiers for at least two wearable devices are all greater than the preset quantity, determining, by the processor, an alarm signal transmission order for each of the at least two wearable devices according to user information emitted by each wearable device; and emitting, for each wearable device, according to the alarm signal transmission order for each wearable device, the alarm signal used to inform that a to-be-located object is at a dangerous location.

According to a fourth aspect, a method for determining a location of an in-water object is provided, including:

receiving, by a first wearable device, electrical signals emitted by at least three sensors, where the first wearable device is located on a to-be-located object and is placed in water, and the sensors are placed in the water;

determining, by the first wearable device according to a received electrical signal emitted by each of the at least three sensors, a received signal strength indicator RSSI value of the received electrical signal emitted by each sensor;

determining, by the first wearable device, a distance between the first wearable device and each sensor according to each determined RSSI value; and

determining, by the first wearable device, a location of the first wearable device in the water according to a pre-measured location of each sensor and the distance between the first wearable device and each sensor, and using the location as a location of the to-be-located object in the water.

With reference to the fourth aspect, in a first possible implementation of the fourth aspect, the first wearable device receives, at intervals of preset time, electrical signals emitted by the at least three sensors.

With reference to the first possible implementation of the fourth aspect, in a second possible implementation of the fourth aspect, after the determining, by the first wearable device, a location of the first wearable device in the water, the method further includes:

determining, by the first wearable device, a distance between the first wearable device and a surface of the water according to the determined location;

after determining that the distance between the first wearable device and the surface of the water is greater than a preset drowning height, increasing, by the first wearable device, a quantity of consecutive set-to-1 drowning identifiers by 1; and

if determining that the quantity of consecutive set-to-1 drowning identifiers is greater than a preset quantity, emitting, by the first wearable device, an alarm signal used to inform that the to-be-located object is at a dangerous location.

With reference to the second possible implementation of the fourth aspect, in a third possible implementation of the fourth aspect, the method further includes:

if determining that the quantity of consecutive set-to-1 drowning identifiers is not greater than the preset quantity, storing, by the first wearable device, a current drowning identifier as 1 in a preset database; and emitting a prompt signal used to inform that the to-be-located object is at a potentially dangerous location.

With reference to the fourth aspect, the first possible implementation of the fourth aspect, the second possible implementation of the fourth aspect, or the third possible implementation of the fourth aspect, in a fourth possible implementation of the fourth aspect, the method further includes:

receiving, by the first wearable device, an electrical signal emitted by a second wearable device;

determining, by the first wearable device according to the received electrical signal emitted by the second wearable device, an RSSI value of the received electrical signal emitted by the second wearable device;

determining, by the first wearable device, a distance between the first wearable device and the second wearable device according to the determined RSSI value of the received electrical signal emitted by the second wearable device; and

after determining that the distance between the first wearable device and the second wearable device is greater than a preset dangerous distance, emitting, by the first wearable device, a rescue prompt signal.

According to a fifth aspect, a processor for determining a location of an in-water object is provided, including:

a first receiving module, configured to receive, for any wearable device placed in water, received signal strength indicator RSSI values sent by at least three sensors, where the RSSI value is an RSSI value of an electrical signal that is emitted by the wearable device and received by the sensor, the wearable device is located on a to-be-located object, and the sensors are placed in the water;

a first distance determining module, configured to determine, according to each received RSSI value, a distance between the wearable device and a sensor that sends the RSSI value; and

a location determining module, configured to: determine a location of the wearable device in the water according to a pre-measured location of each sensor and the determined distance between the wearable device and each sensor that sends the RSSI value, and use the location as a location of the to-be-located object in the water.

With reference to the fifth aspect, in a first possible implementation of the fifth aspect, the first receiving module receives, at intervals of preset time, the RSSI values sent by the at least three sensors.

With reference to the first possible implementation of the fifth aspect, in a second possible implementation of the fifth aspect, the processor further includes:

a second distance determining module, configured to determine a distance between the wearable device and a surface of the water according to the determined location;

a distance judging module, configured to: after determining that the distance between the wearable device and the surface of the water is greater than a preset drowning height, increase a quantity of consecutive set-to-1 drowning identifiers by 1; and

a first alarm module, configured to: if determining that the quantity of consecutive set-to-1 drowning identifiers is greater than a preset quantity, emit an alarm signal used to inform that the to-be-located object is at a dangerous location.

With reference to the second possible implementation of the fifth aspect, in a third possible implementation of the fifth aspect, the to-be-located object is a user; the first receiving module is further configured to:

receive, by using the sensor, user information of the user that is sent by the wearable device by using the sensor;

the first alarm module is specifically configured to: if determining that quantities of consecutive set-to-1 drowning identifiers for at least two wearable devices are all greater than the preset quantity, determine an alarm signal transmission order for each of the at least two wearable devices according to user information emitted by each wearable device; and

emit, for each wearable device, according to the alarm signal transmission order for each wearable device, the alarm signal used to inform that a to-be-located object is at a dangerous location.

According to a sixth aspect, a wearable device for determining a location of an in-water object is provided, including:

a second receiving module, configured to receive electrical signals emitted by at least three sensors, where the wearable device is located on a to-be-located object and is placed in water, and the sensors are placed in the water;

a determining module, configured to determine, according to a received electrical signal emitted by each of the at least three sensors, a received signal strength indicator RSSI value of the received electrical signal emitted by each sensor;

a third distance determining module, configured to determine a distance between the wearable device and each sensor according to each determined RSSI value; and

a locating module, configured to: determine a location of the wearable device in the water according to a pre-measured location of each sensor and the distance between the wearable device and each sensor, and use the location as a location of the to-be-located object.

With reference to the sixth aspect, in a first possible implementation of the sixth aspect, the second receiving module receives, at intervals of preset time, electrical signals emitted by the at least three sensors.

With reference to the first possible implementation of the sixth aspect, in a second possible implementation of the sixth aspect, the wearable device further includes:

a fourth distance determining module, configured to determine a distance between the wearable device and a surface of the water according to the determined location of the wearable device in the water;

a height judging module, configured to: after determining that the distance between the wearable device and the surface of the water is greater than a preset drowning height, increase a quantity of consecutive set-to-1 drowning identifiers by 1; and

a second alarm module, configured to: if determining that the quantity of consecutive set-to-1 drowning identifiers is greater than a preset quantity, emit an alarm signal used to inform that the to-be-located object is at a dangerous location.

With reference to the second possible implementation of the sixth aspect, in a third possible implementation of the sixth aspect, the second alarm module is further configured to: if determining that the quantity of consecutive set-to-1 drowning identifiers is not greater than the preset quantity, store a current drowning identifier as 1 in a preset database; and emit a prompt signal used to inform that the to-be-located object is at a potentially dangerous location.

With reference to the sixth aspect, the first possible implementation of the sixth aspect, the second possible implementation of the sixth aspect, or the third possible implementation of the sixth aspect, in a fourth possible implementation of the sixth aspect, the second receiving module is further configured to:

receive an electrical signal emitted by a second wearable device;

the determining module is further configured to:

determine, according to the received electrical signal emitted by the second wearable device, an RSSI value of the received electrical signal emitted by the second wearable device;

the third distance determining module is further configured to:

determine a distance between the wearable device and the second wearable device according to the determined RSSI value of the received electrical signal emitted by the second wearable device; and

the second alarm module is further configured to:

after determining that the distance between the wearable device and the second wearable device is greater than a preset dangerous distance, emit a rescue prompt signal.

According to the embodiments of the present invention, the location of the to-be-located object in the water is determined by using the RSSI value of the electrical signal. Therefore, determining a location of an in-water object is less affected by environmental and human factors, and reliability of determining the location of the in-water object is improved.

### BRIEF DESCRIPTION OF DRAWINGS

FIG. 1 is a schematic diagram of a system for determining a location of an in-water object according to an embodiment of the present invention;

FIG. 2 is a schematic diagram of a location of a device of a system in water according to an embodiment of the present invention;

FIG. 3 is a schematic diagram of a principle of determining a location of a wearable device according to an embodiment of the present invention;

FIG. 4 is a schematic diagram of determining a distance between a wearable device and a surface of water according to an embodiment of the present invention;

FIG. 5 is a schematic flowchart of a method for determining a location of an in-water object according to an embodiment of the present invention;

FIG. 6 is a schematic diagram of a processor for determining a location of an in-water object according to an embodiment of the present invention;

FIG. 7 is a schematic diagram of a system for determining a location of an in-water object according to an embodiment of the present invention;

FIG. 8 is a schematic diagram of a location of a device of a system in water according to an embodiment of the present invention;

FIG. 9 is a schematic diagram of a principle of determining a location of a wearable device according to an embodiment of the present invention;

FIG. 10 is a schematic diagram of determining a distance between a wearable device and a surface of water according to an embodiment of the present invention;

FIG. 11 is a schematic diagram of determining a distance between a first wearable device and a second wearable device according to an embodiment of the present invention;

FIG. 12 is a schematic flowchart of a method for determining a location of an in-water object according to an embodiment of the present invention; and

FIG. 13 is a schematic diagram of a wearable device for determining a location of an in-water object according to an embodiment of the present invention.

### DESCRIPTION OF EMBODIMENTS

A system for determining a location of an in-water object provided in the embodiments of the present invention includes a wearable device, at least three sensors, and a processor. The wearable device is located on a to-be-located object, the to-be-located object is placed in water, and the wearable device is configured to emit an electrical signal. Each sensor is placed in the water, and is configured to: determine a received signal strength indicator RSSI value of a received electrical signal emitted by the wearable device, and send the determined RSSI value to the processor. The processor is located on ground, and is configured to: determine, according to the RSSI value sent by each sensor, a distance between the sensor that sends the RSSI value and the wearable device, determine a location of the wearable device in the water according to a pre-measured location of each sensor and the determined distance between each sensor and the wearable device, and use the location as a location of the to-be-located object in the water. According to this technical solution, the location of the to-be-located object in the water is determined by using the RSSI value of the electrical signal. Therefore, determining a location of an in-water object is less affected by environmental and human factors, and reliability of determining the location of the in-water object is improved.

The following further describes the embodiments of the present invention in detail with reference to the specifications.

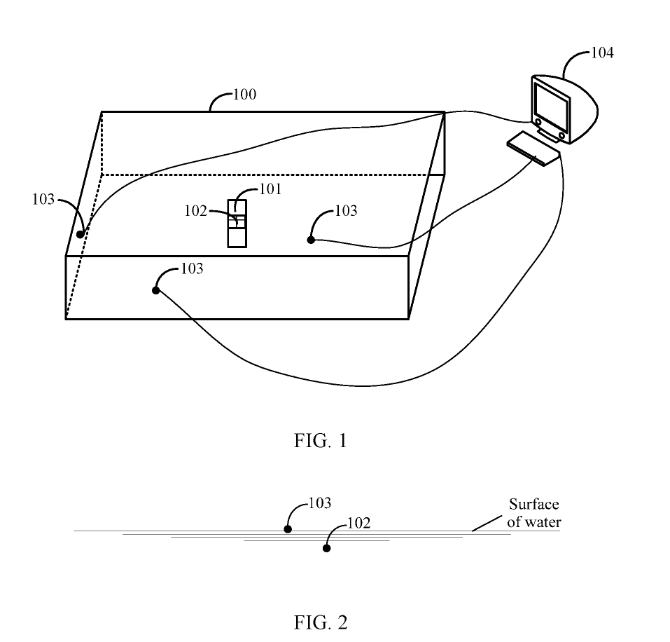

As shown in FIG. 1, a system for determining a location of an in-water object according to an embodiment of the present invention includes:

a wearable device 102, at least three sensors 103, and a processor 104, where 100 represents a water pool, and 101 represents a to-be-located object.

The wearable device 102 is located on the to-be-located object 101, the to-be-located object 101 is placed in water, and the wearable device 102 is configured to emit an electrical signal.

Each sensor 103 is placed in the water, and is configured to: determine a received signal strength indicator RSSI value of the received electrical signal emitted by the wearable device 102, and send the determined RSSI value to the processor 104.

The processor 104 is located on ground, and is configured to: determine, according to the RSSI value sent by each sensor 103, a distance between the sensor 103 that sends the RSSI value and the wearable device 102, determine a location of the wearable device 103 in the water according to a pre-measured location of each sensor and the determined distance between each sensor 103 and the wearable device 102, and use the location as a location of the to-be-located object 101 in the water.

It should be noted that the to-be-located object 101, the wearable device 102, and the sensors 103 are placed in the water in two manners. In one manner, one or more of the to-be-located object 101, the wearable device 102, or the sensors 103 are partially in the water. In the other manner, one or more of the to-be-located object 101, the wearable device 102, or the sensors 103 are entirely in the water.

As shown in FIG. 2, the sensor 103 is partially in the water, and the wearable device 102 is entirely in the water.

When the sensor 103 is partially in the water, the sensor 103 may be connected to the processor 104 in a wireless manner, or may be connected to the processor 104 in a wired manner. When the sensor 103 is entirely in the water, the sensor 103 is connected to the processor 104 in a wired manner.

The sensor 103 in this embodiment of the present invention may be placed at a specific location in the water in advance according to an actual requirement, or the sensor 103 may be randomly placed in the water. The sensor 103 in this embodiment of the present invention may be a sensor based on a BAN (Body Area Network, body area network), or another sensor that can be used to receive an electrical signal in the water.

After detecting, by using atmospheric pressure or in another manner, that the wearable device 102 in this embodiment of the present invention is located in a water environment, the wearable device 102 emits an electrical signal, or the wearable device 102 is manually made to emit an electrical signal.

Optionally, the wearable device 102 emits an electrical signal at intervals of preset duration. The preset duration is set in the wearable device in advance according to an actual requirement. Optionally, when the to-be-located object is a user, the preset duration needs to be less than 240 seconds because maximum duration that the user can stand before drowning is 240 seconds.

When the wearable device 102 emits an electrical signal at intervals of the preset duration, the processor 104 determines the location of the to-be-located object in the water once at intervals of the preset duration.

Specifically, according to the RSSI value sent by the sensor 103, the distance between the sensor 103 that sends the RSSI value and the wearable device 102 is determined by using the following formula (1) indicating a relationship between an RSSI value and a distance:

RSSI(d)=A−10 nlg(d) (1)

where d represents a distance between a receive point and a transmit point; n represents an attenuation rate of signal energy as the distance between the receive point and the transmit point increases, and a value of n depends on a propagation environment of a radio signal; A represents an absolute value of average energy of received signals when the receive point is 1 m away from the transmit point, and assuming that the average energy is −20 dBm, the parameter A is 20.

In this embodiment of the present invention, the transmit point is the wearable device 102, and the receive point is the sensor 103.

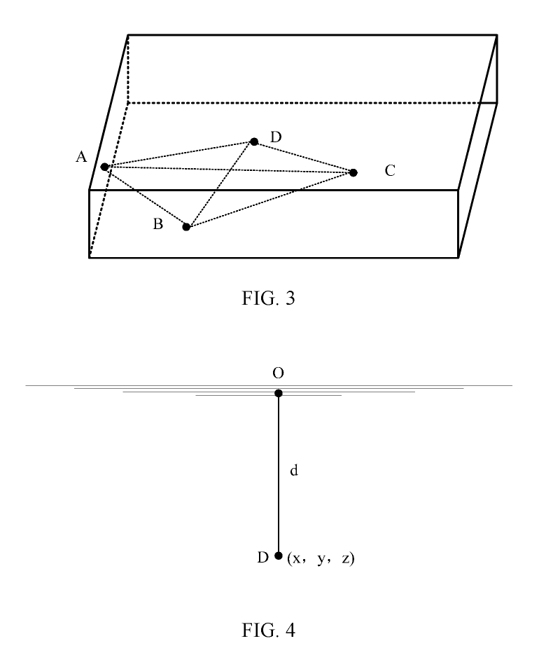

As shown in FIGS. 3, A, B, and C are locations of the sensors 103, and D is a location of the wearable device in the water. Distances between A and D, B and D, and C and D are obtained by using the formula (1). A coordinate system is established by using A, B, C, a middle point of a surface of the water, or another point as an origin. Location coordinates of the point D in the water are obtained by using a geometric relationship according to the locations A, B, and C of the sensors 103 and the distances between A and D, B and D, and C and D, and are used as the location of the wearable device in the water. The location is a location of the to-be-located object in the water.

Specifically, if the coordinate system is established by using the middle point on the surface of the water as the origin, coordinates (x_{A},y_{A},z_{A}) of the point A, coordinates (x_{B},y_{B},z_{B}) of the point B, and coordinates (x_{C},y_{C},z_{C}) of the point C are obtained through pre-measurement, and the distances between A and D, B and D, and C and D are d₁,d₂,d₃, respectively, the location (x,y,z) of the wearable device in the water is obtained by using an equation set:

$$\{ \begin{matrix}{d}_{1} = \sqrt{{( {x}_{A} - x )}^{2} + {( {y}_{A} - y )}^{2} + {( {z}_{A} - z )}^{2}} \\ {d}_{2} = \sqrt{{( {x}_{B} - x )}^{2} + {( {y}_{B} - y )}^{2} + {( {z}_{B} - z )}^{2}} \\ {d}_{3} = \sqrt{{( {x}_{C} - x )}^{2} + {( {y}_{C} - y )}^{2} + {( {z}_{C} - z )}^{2}}\end{matrix} .$$

When there are more than three sensors, a manner of determining the location of the wearable device in the water is similar to a manner of determining the location of the wearable device in the water when there are three sensors. Details are not repeated herein.

After determining the location of the wearable device 102 in the water, optionally, the processor 104 determines a distance between the wearable device 102 and the surface of the water according to the determined location of the wearable device 102 in the water; after determining that the distance between the wearable device 102 and the surface of the water is greater than a preset drowning height, increases a quantity of consecutive set-to-1 drowning identifiers by 1; and if determining that the quantity of consecutive set-to-1 drowning identifiers is greater than a preset quantity, emits an alarm signal used to inform that the to-be-located object is at a dangerous location.

FIG. 4 is used as an example for description. Assuming that a coordinate system is established by using a middle point O on the surface of the water as an origin and a point D is the location (x, y, z) of the wearable device 102, a distance D between the wearable device 102 and O on the surface of the water is the distance between the wearable device 102 and the surface of the water.

If determining that D is greater than the preset drowning height, the processor 104 increases the quantity of consecutive set-to-1 drowning identifiers by 1. The preset drowning height is set according to an actual height of the to-be-located object. For example, the actual height of the to-be-located object is H₁, and the preset drowning height is H=r*H₁, where r is a variable parameter and is set according to an actual requirement. For example, if the actual height H₁ is 1.7 meters, r is set to 1.5; if the actual height H₁ is 0.7 meter, r is set to 1.

The increasing a quantity of consecutive set-to-1 drowning identifiers by 1 is described in detail by using two cases shown in Table 1 and Table 2 as examples.

A drowning identifier is determined once at intervals of preset time. As shown in Table 1, the drowning identifier is determined to be 0 at a first time, and a quantity of consecutive set-to-0 drowning identifiers is 1. The drowning identifier is determined to be 1 at a second time, and a quantity of consecutive set-to-1 drowning identifiers is 1. The drowning identifier is determined to be 1 at a third time, and the drowning identifier is also determined to be 1 at the second time; therefore, the quantity of consecutive set-to-1 drowning identifiers is 2. By analogy, the drowning identifier is determined to be 1 at a fourth time, and the quantity of consecutive set-to-1 drowning identifiers is 3. The drowning identifier is determined to be 0 at a fifth time while the drowning identifier is determined to be 1 at the fourth time; therefore, the quantity of consecutive set-to-0 drowning identifiers is 1. This is because the determining result 0 is non-consecutive although the drowning identifier is determined to be 0 at the first time, and the quantity of consecutive set-to-0 drowning identifiers is determined to be 1 again. Likewise, the drowning identifier is determined to be 1 at a seventh time while the drowning identifier is determined to be 0 at a sixth time; therefore, the quantity of consecutive set-to-1 drowning identifiers is 1. This is because this time with the drowning identifier being 1 is non consecutive to the previous times that the drowning identifier is determined to be 1, and the quantity of consecutive set-to-1 drowning identifiers needs to be determined to be 1 again.

In Table 1, before the drowning identifier is determined to be 1 at a thirteenth time, the drowning identifier is determined to be 1 for six consecutive times from the seventh time to a twelfth time. Therefore, after D is determined to be greater than the preset drowning height, the quantity of consecutive set-to-1 drowning identifiers is increased by 1 and the quantity of consecutive set-to-1 drowning identifiers is 7.

If the wearable device emits an electrical signal every 35 seconds and the preset quantity is set to 6, the quantity of consecutive set-to-1 drowning identifiers is determined to be greater than the preset quantity 6, that is, 7 is greater than 6; therefore, an alarm signal used to inform that the to-be-located object is at a dangerous location is emitted.

TABLE 1

| | Quantity of consecutive set-to-0 or set-to-1 drowning identifiers | | | | | | | | | | | |
|---|---|---|---|---|---|---|---|---|---|---|---|---|
| | 1 | 1 | 2 | 3 | 1 | 2 | 1 | 2 | 3 | 4 | 5 | 6 |
| Drowning identifier | 0 | 1 | 1 | 1 | 0 | 0 | 1 | 1 | 1 | 1 | 1 | 1 |

Using Table 2 as an example, before the drowning identifier is determined to be 1 at a thirteenth time, the drowning identifier is determined to be 0 at a twelfth time. After D is determined to be greater than the preset drowning height, the quantity of consecutive set-to-1 drowning identifiers is increased by 1, and the quantity of consecutive set-to-1 drowning identifiers is 1.

TABLE 2

| | Quantity of consecutive set-to-0 or set-to-1 drowning identifiers | | | | | | | | | | | |
|---|---|---|---|---|---|---|---|---|---|---|---|---|
| | 1 | 1 | 2 | 3 | 4 | 5 | 6 | 7 | 1 | 1 | 2 | 1 |
| Drowning identifier | 0 | 1 | 1 | 1 | 1 | 1 | 1 | 1 | 0 | 1 | 1 | 0 |

In addition, using Table 2 as an example, if the distance between the wearable device 102 and the surface of the water is not greater than the preset drowning height, the quantity of consecutive set-to-0 drowning identifiers is increased by 1, and the drowning identifier 0 is stored in a database that stores a correspondence between a drowning identifier and a quantity of consecutive set-to-0 or set-to-1 drowning identifiers, as shown in Table 3.

TABLE 3

| | Quantity of consecutive set-to-0 or set-to-1 drowning identifiers | | | | | | | | | | | | |
|---|---|---|---|---|---|---|---|---|---|---|---|---|---|
| | 1 | 1 | 2 | 3 | 4 | 5 | 6 | 7 | 1 | 1 | 2 | 1 | 2 |
| Drowning identifier | 0 | 1 | 1 | 1 | 1 | 1 | 1 | 1 | 0 | 1 | 1 | 0 | 0 |

If the distance between the wearable device 102 and the surface of the water is greater than the preset drowning height, the quantity of consecutive set-to-1 drowning identifiers is increased by 1. If the quantity of consecutive set-to-1 drowning identifiers is not greater than the preset quantity, the drowning identifier 1 is stored in the database that stores the correspondence between a drowning identifier and a quantity of consecutive set-to-1 or set-to-0 drowning identifiers, as shown in Table 4.

TABLE 4

| | Quantity of consecutive set-to-0 or set-to-1 drowning identifiers | | | | | | | | | | | | |
|---|---|---|---|---|---|---|---|---|---|---|---|---|---|
| | 1 | 1 | 2 | 3 | 4 | 5 | 6 | 7 | 1 | 1 | 2 | 1 | 1 |
| Drowning identifier | 0 | 1 | 1 | 1 | 1 | 1 | 1 | 1 | 0 | 1 | 1 | 0 | 1 |

In addition, as shown in Table 5, a correspondence between a drowning identifier determining time and a drowning identifier may be stored in a corresponding database. The drowning identifier is determined once every 35 seconds. The drowning identifier is determined to be 0 at a 00th second, the drowning identifier is determined to be 1 at a 35^{th} second, and, by analogy, the drowning identifier is determined to be 1 at a 280th second. The drowning identifier is consecutively determined to be 1 from the 35^{th} second to the 280^{th} second, and an in-between time interval is 245 seconds. Assuming that preset drowning duration is 240 seconds, 245 seconds is greater than 240 seconds and an alarm is emitted. The drowning identifier is consecutively determined to be 1 from the 35^{th} second to a 245^{th} second, and an in-between time interval is 210 seconds, less than 240 seconds; therefore, no alarm is emitted. The preset drowning duration is determined according to prime rescue duration for drowning. Generally, the prime rescue duration is 240 seconds.

TABLE 5

| | Time for determining a drowning identifier (second) | | | | | | | | |
|---|---|---|---|---|---|---|---|---|---|
| | 00 | 35 | 70 | 105 | 140 | 175 | 210 | 245 | 280 |
| Drowning identifier | 0 | 1 | 1 | 1 | 1 | 1 | 1 | 1 | 1 |

Optionally, when the to-be-located object 101 is a user, the wearable device 102 sends, to the sensor 103, user information of the user that wears the wearable device 102.

The sensor 103 sends the received user information to the processor 104.

If determining that quantities of consecutive set-to-1 drowning identifiers for at least two wearable devices are all greater than the preset quantity, the processor 104 determines an alarm signal transmission order for each of the at least two wearable devices according to user information emitted by each wearable device; and emits, for each wearable device, according to the alarm signal transmission order for each wearable device, an alarm signal used to inform that a to-be-located object is at a dangerous location.

The user information may include information such as user age, years of swimming, gender, and height of the user, and a data transmission time stamp.

Using the years of swimming of the user as an example, after the processor 104 determines that the quantities of consecutive set-to-1 drowning identifiers for the at least two wearable devices are all greater than the preset quantity, because the years of swimming of a user of one wearable device is longer, the processor 104 emits, for each wearable device according to an ascending order of years of swimming, an alarm signal used to inform that the to-be-located object is at a dangerous location.

When there are a plurality of pieces of user information, a priority of the user information is pre-configured in the processor according to an actual requirement, and then an alarm signal transmission order is determined. For example, when the alarm signal transmission order is determined by using the years of swimming and the user age, and when the user age is at least 65 years old or not greater than 16 years old, the years of swimming has a higher priority than the user age. When the quantity of consecutive set-to-1 drowning identifiers for a wearable device with the user age being 30 years old and the years of swimming being 1 year and that for a wearable device with the user age being 69 years old and the years of swimming being 2 years are both greater than the preset quantity, an alarm signal used to inform that the user is at a dangerous location is emitted for the wearable device with the user age being 69 years old and the years of swimming being 2 years.

Based on a same inventive concept, an embodiment of the present invention further provides a method for determining a location of an in-water object. A system corresponding to the method for determining a location of an in-water object in this embodiment of the present invention is the system for determining a location of an in-water object. Therefore, for implementation of the method in this embodiment of the present invention, reference may be made to the implementation of the system. Details are not repeated herein.

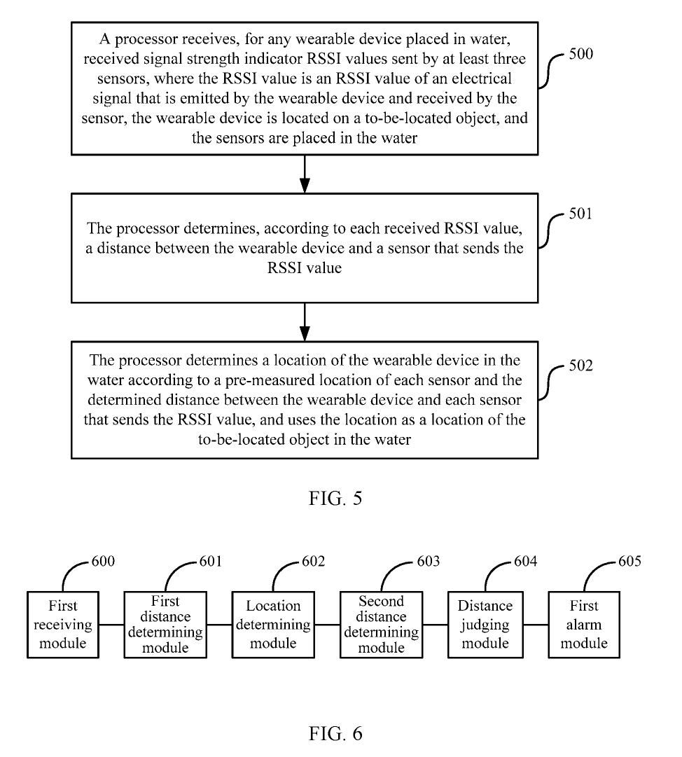

As shown in FIG. 5, a method for determining a location of an in-water object in an embodiment of the present invention includes the following steps.

Step 500. A processor receives, for any wearable device placed in water, received signal strength indicator RSSI values sent by at least three sensors, where the RSSI value is an RSSI value of an electrical signal that is emitted by the wearable device and received by the sensor, the wearable device is located on a to-be-located object, and the sensors are placed in the water.

Step 501. The processor determines, according to each received RSSI value, a distance between the wearable device and a sensor that sends the RSSI value.

Step 502. The processor determines a location of the wearable device in the water according to a pre-measured location of each sensor and the determined distance between the wearable device and each sensor that sends the RSSI value, and uses the location as a location of the to-be-located object in the water.

Optionally, the processor receives, at intervals of preset time, the RSSI values sent by the at least three sensors.

Optionally, after the processor determines the location, the method further includes:

determining, by the processor, a distance between the wearable device and a surface of the water according to the determined location;

after determining that the distance between the wearable device and the surface of the water is greater than a preset drowning height, increasing, by the processor, a quantity of consecutive set-to-1 drowning identifiers by 1; and

emitting, by the processor, if determining that the quantity of consecutive set-to-1 drowning identifiers is greater than a preset quantity, an alarm signal used to inform that the to-be-located object is at a dangerous location.

Optionally, the to-be-located object is a user.

The method further includes:

receiving, by the processor, user information of the user that is sent by the wearable device by using the sensor; and

the emitting, by the processor, if determining that the quantity of consecutive set-to-1 drowning identifiers is greater than a preset quantity, an alarm signal used to inform that the to-be-located object is at a dangerous location includes:

if determining that quantities of consecutive set-to-1 drowning identifiers for at least two wearable devices are all greater than the preset quantity, determining, by the processor, an alarm signal transmission order for each of the at least two wearable devices according to user information emitted by each wearable device; and emitting, for each wearable device, according to the alarm signal transmission order for each wearable device, an alarm signal used to inform that a to-be-located object is at a dangerous location.

Based on a same inventive concept, an embodiment of the present invention further provides a processor for determining a location of an in-water object. A system corresponding to the processor for determining a location of an in-water object in this embodiment of the present invention is the system for determining a location of an in-water object. Therefore, for implementation of the processor in this embodiment of the present invention, reference may be made to the implementation of the system. Details are not repeated herein.

As shown in FIG. 6, a processor for determining a location of an in-water object in an embodiment of the present invention includes:

a first receiving module 600, configured to receive, for any wearable device placed in water, received signal strength indicator RSSI values sent by at least three sensors, where the RSSI value is an RSSI value of an electrical signal that is emitted by the wearable device and received by the sensor, the wearable device is located on a to-be-located object, and the sensors are placed in the water;

a first distance determining module 601, configured to determine, according to each received RSSI value, a distance between the wearable device and a sensor that sends the RSSI value; and

a location determining module 602, configured to: determine a location of the wearable device in the water according to a pre-measured location of each sensor and the determined distance between the wearable device and each sensor that sends the RSSI value, and use the location as a location of the to-be-located object in the water.

Optionally, the first receiving module 600 receives, at intervals of preset time, the RSSI values sent by the at least three sensors.

Optionally, the processor further includes:

a second distance determining module 603, configured to determine a distance between the wearable device and a surface of the water according to the determined location;

a distance judging module 604, configured to: after determining that the distance between the wearable device and the surface of the water is greater than a preset drowning height, increase a quantity of consecutive set-to-1 drowning identifiers by 1; and

a first alarm module 605, configured to: if determining that the quantity of consecutive set-to-1 drowning identifiers is greater than a preset quantity, emit an alarm signal used to inform that the to-be-located object is at a dangerous location.

Optionally, the to-be-located object is a user.

The first receiving module 600 is further configured to:

receive, by using the sensor, user information of the user that is sent by the wearable device by using the sensor.

The first alarm module 605 is specifically configured to: if determining that quantities of consecutive set-to-1 drowning identifiers for at least two wearable devices are all greater than the preset quantity, determine an alarm signal transmission order for each of the at least two wearable devices according to user information emitted by each wearable device; and emit, for each wearable device, according to the alarm signal transmission order for each wearable device, the alarm signal used to inform that a to-be-located object is at a dangerous location.

In this embodiment of the present invention, the module division is an example, and is merely logical function division and may be another division manner in actual implementation. In addition, the functional modules in this embodiment of this application may be integrated into one processing module, or each of the modules may exist alone physically, or two or more modules may be integrated into one module. The integrated module may be implemented in a form of hardware, or may be implemented in a form of a software functional module.

When the integrated unit is implemented in a form of hardware, physical hardware, corresponding to the first receiving module 600, of the processor is a transceiver. Physical hardware, corresponding to the first distance determining module 601, the location determining module 602, the second distance determining module 603, and the distance judging module 604, of the processor is a processing unit. Physical hardware, corresponding to the first alarm module 605, of the processor is a speaker or the like.

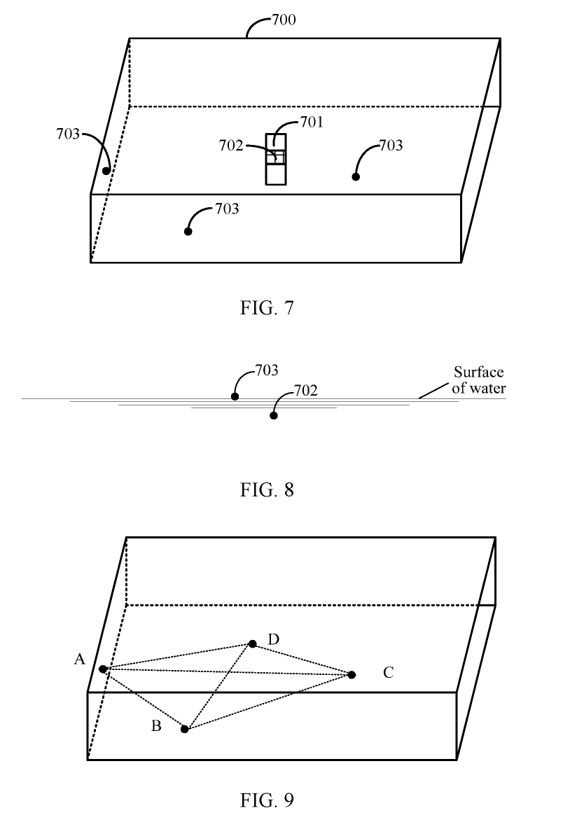

As shown in FIG. 7, a system for determining a location of an in-water object according to an embodiment of the present invention includes:

a first wearable device 702 and at least three sensors 703, where 700 represents a water pool, and 701 represents a to-be-located object.

Each sensor 703 is placed in water, and is configured to emit an electrical signal.

The first wearable device 702 is located on the to-be-located object 701, and the to-be-located object 701 is placed in the water. The first wearable device 702 is configured to:

separately determine received signal strength indicator RSSI values of received electrical signals emitted by the at least three sensors 703, determine a distance between the first wearable device 702 and each sensor according to the determined RSSI value, determine a location of the first wearable device 702 in the water according to a pre-measured location of each sensor and the determined distance between the first wearable device 702 and each sensor 703, and use the location as a location of the to-be-located object 701 in the water.

It should be noted that the to-be-located object 701, the first wearable device 702, the sensors 703 are placed in the water in two manners. In one manner, the to-be-located object 701, the first wearable device 702, and the sensors 703 are partially in the water. In the other manner, the to-be-located object 701, the wearable device 702, and the sensors 703 are entirely in the water.

As shown in FIG. 8, the sensor 703 is partially in the water, and the wearable device 702 is entirely in the water.

The sensor 703 in this embodiment of the present invention may be placed at a specific location in the water in advance according to an actual requirement, or the sensor 703 may be randomly placed in the water. The sensor 703 in this embodiment of the present invention may be a sensor based on a BAN (Body Area Network, body area network), or another sensor that can be used to emit an electrical signal in the water.

After detecting, by using atmospheric pressure or in another manner, that the first wearable device 702 in this embodiment of the present invention is located in a water environment, the first wearable device 702 receives the electrical signals emitted by the sensors 703, or the first wearable device 702 is manually made to receive the electrical signals emitted by the sensors 703.

Optionally, the sensor 703 emits an electrical signal at intervals of preset duration. The preset duration is set in the sensor 703 in advance according to an actual requirement.

Optionally, when the to-be-located object is a user, the preset duration needs to be less than 240 seconds because maximum duration that the user can stand before drowning is 240 seconds.

When the sensor 703 emits an electrical signal at intervals of the preset duration, the first wearable device 702 determines the location of the to-be-located object in the water once at intervals of the preset duration.

Specifically, the first wearable device 702 determines the RSSI value of each sensor 703 according to the received electrical signal, and determines, by using a formula (1) indicating a relationship between an RSSI value and a distance, the distance between the sensor 703 that sends the electrical signal and the first wearable device 702.

In this embodiment of the present invention, a transmit point is the sensor 703, and a receive point is the first wearable device 702.

As shown in FIGS. 9, A, B, and C are locations of the sensors 703, and D is a location of the first wearable device in the water. Distances between A and D, B and D, and C and D are obtained by using the formula (1). A coordinate system is established by using A, B, C, a middle point of a surface of the water, or another point as an origin. Location coordinates of the point D in the water are obtained by using a geometric relationship according to the locations A, B, and C of the sensors 703 and the distances between A and D, B and D, and C and D, and are used as the location of the first wearable device 702 in the water. The location is a location of the to-be-located object 701 in the water.

Specifically, if the coordinate system is established by using the middle point on the surface of the water as the origin, coordinates (x_{A},y_{A},z_{A}) of the point A, coordinates (x_{B},y_{B},z_{B}) of the point B, and coordinates (x_{C},y_{C},z_{C}) of the point C are obtained through pre-measurement, and the distances between A and D, B and D, and C and D are d₁,d₂,d₃, respectively, the location (x, y, z) of the wearable device in the water is obtained by using an equation set:

$$\{ \begin{matrix}{d}_{1} = \sqrt{{( {x}_{A} - x )}^{2} + {( {y}_{A} - y )}^{2} + {( {z}_{A} - z )}^{2}} \\ {d}_{2} = \sqrt{{( {x}_{B} - x )}^{2} + {( {y}_{B} - y )}^{2} + {( {z}_{B} - z )}^{2}} \\ {d}_{3} = \sqrt{{( {x}_{C} - x )}^{2} + {( {y}_{C} - y )}^{2} + {( {z}_{C} - z )}^{2}}\end{matrix} .$$

When there are more than three sensors, a manner of determining the location of the wearable device in the water is similar to a manner of determining the location of the wearable device in the water when there are three sensors. Details are not repeated herein.

After determining the location of the first wearable device 702 in the water, optionally, the first wearable device 702 determines a distance between the first wearable device 702 and the surface of the water according to the determined location of the first wearable device 702 in the water; after determining that the distance between the first wearable device 702 and the surface of the water is greater than a preset drowning height, increases a quantity of consecutive set-to-1 drowning identifiers by 1; and if determining that the quantity of consecutive set-to-1 drowning identifiers is greater than a preset quantity, emits an alarm signal used to inform that the to-be-located object is at a dangerous location.

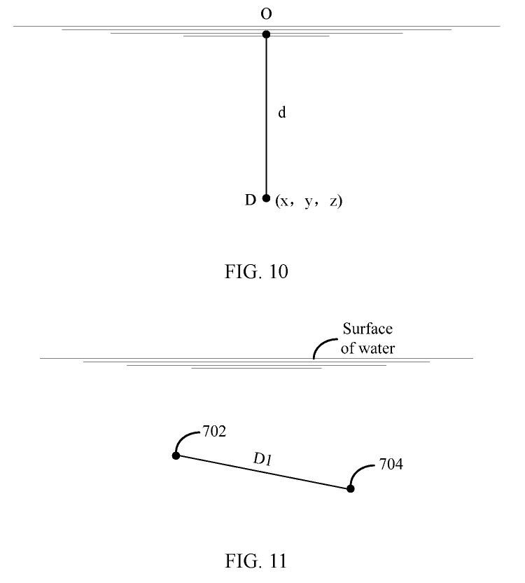

FIG. 10 is used as an example for description. Assuming that a coordinate system is established by using a middle point O on the surface of the water as an origin, and a point D is the location (x, y, z) of the first wearable device 702, a distance D between the first wearable device 702 and O on the surface of the water is the distance between the first wearable device 702 and the surface of the water.

If determining that D is greater than the preset drowning height, the first wearable device 702 increases the quantity of consecutive set-to-1 drowning identifiers by 1. The preset drowning height is set according to an actual height of the to-be-located object. For example, the actual height of the to-be-located object is H₁, and the preset drowning height is H=r*H₁, where r is a variable parameter and is set according to an actual requirement. For example, if the actual height H₁ is 1.7 meters, r is set to 1.5; if the actual height H₁ is 0.7 meter, r is set to 1.

Table 6 is used as an example for detailed description.

A drowning identifier is determined once at intervals of preset time. As shown in Table 6, the drowning identifier is determined to be 0 at a first time, and a quantity of consecutive set-to-0 drowning identifiers is 1. The drowning identifier is determined to be 1 at a second time, and a quantity of consecutive set-to-1 drowning identifiers is 1. The drowning identifier is determined to be 1 at a third time, and the drowning identifier is also determined to be 1 at the second time; therefore, the quantity of consecutive set-to-1 drowning identifiers is 2. By analogy, the drowning identifier is determined to be 1 at a fourth time, and the quantity of consecutive set-to-1 drowning identifiers is 3. The drowning identifier is determined to be 0 at a fifth time while the drowning identifier is determined to be 1 at the fourth time; therefore, the quantity of consecutive set-to-0 drowning identifiers is 1. This is because the determining result 0 is non-consecutive although the drowning identifier is determined to be 0 at the first time, and the quantity of consecutive set-to-0 drowning identifiers is determined to be 1 again. Likewise, the drowning identifier is determined to be 1 at a seventh time while the drowning identifier is determined to be 0 at a sixth time; therefore, the quantity of consecutive set-to-1 drowning identifiers is 1. This is because this time with the drowning identifier being 1 is non consecutive to the previous times that the drowning identifier is determined to be 1, and the quantity of consecutive set-to-1 drowning identifiers needs to be determined to be 1 again.

In Table 6, before the drowning identifier is determined to be 1 at a thirteenth time, the drowning identifier is determined to be 1 for six consecutive times from the seventh time to a twelfth time. Therefore, after D is determined to be greater than the preset drowning height, the quantity of consecutive set-to-1 drowning identifiers is increased by 1, and the quantity of consecutive set-to-1 drowning identifiers is 7.

If the first wearable device 702 emits an electrical signal every 35 seconds and the preset quantity is set to 6, the quantity of consecutive set-to-1 drowning identifiers is determined to be greater than the preset quantity 6, that is, 7 is greater than 6; therefore, an alarm signal used to inform that the to-be-located object is at a dangerous location is emitted.

TABLE 6

| | Quantity of consecutive set-to-0 or set-to-1 drowning identifiers | | | | | | | | | | | |
|---|---|---|---|---|---|---|---|---|---|---|---|---|
| | 1 | 1 | 2 | 3 | 1 | 2 | 1 | 2 | 3 | 4 | 5 | 6 |
| Drowning identifier | 0 | 1 | 1 | 1 | 0 | 0 | 1 | 1 | 1 | 1 | 1 | 1 |

Optionally, if determining that the quantity of consecutive set-to-1 drowning identifiers is not greater than the preset quantity, the first wearable device 702 stores a current drowning identifier 1 in a database that stores a correspondence between a quantity of consecutive set-to-0 or set-to-1 drowning identifiers and a drowning identifier, and emits a prompt signal used to inform that the to-be-located object is at a potentially dangerous location.

Using Table 7 as an example for description, before the drowning identifier is determined to be 1 at a thirteenth time, the drowning identifier is determined to be 0 at a twelfth time. After D is determined to be greater than the preset drowning height, the quantity of consecutive set-to-1 drowning identifiers is increased by 1, and the quantity of consecutive set-to-1 drowning identifiers is 1. Assuming that the preset quantity is 7, 1 is less than 7; therefore, a current drowning identifier 1 is stored in the database that stores the correspondence between a quantity of consecutive set-to-0 or set-to-1 drowning identifiers and a drowning identifier, as shown in Table 8, and a prompt signal used to inform that the to-be-located object is at a potentially dangerous location is emitted, so that the to-be-located object proactively moves away from the location to avoid danger.

TABLE 7

| Quantity | 1 | 1 | 2 | 3 | 4 | 5 | 6 | 7 | 1 | 1 | 2 | 1 |
|---|---|---|---|---|---|---|---|---|---|---|---|---|
| Drowning | 0 | 1 | 1 | 1 | 1 | 1 | 1 | 1 | 0 | 1 | 1 | 0 |
| identifier | | | | | | | | | | | | |

TABLE 8

| Quantity | 1 | 1 | 2 | 3 | 4 | 5 | 6 | 7 | 1 | 1 | 2 | 1 | 1 |
|---|---|---|---|---|---|---|---|---|---|---|---|---|---|
| Drowning | 0 | 1 | 1 | 1 | 1 | 1 | 1 | 1 | 0 | 1 | 1 | 0 | 1 |
| identifier | | | | | | | | | | | | | |

In addition, using Table 7 as an example, if determining that the distance between the first wearable device 702 and the surface of the water is not greater than the preset drowning height at the thirteenth time, the first wearable device 702 increases the quantity of consecutive set-to-0 drowning identifiers by 1, and stores a drowning identifier 0 in the database that stores the correspondence between a quantity of consecutive set-to-0 or set-to-1 drowning identifiers and a drowning identifier, to obtain Table 9.

TABLE 9

| Quantity | 1 | 1 | 2 | 3 | 4 | 5 | 6 | 7 | 1 | 1 | 2 | 1 | 2 |
|---|---|---|---|---|---|---|---|---|---|---|---|---|---|
| Drowning | 0 | 1 | 1 | 1 | 1 | 1 | 1 | 1 | 0 | 1 | 1 | 0 | 0 |
| identifier | | | | | | | | | | | | | |

In addition, as shown in Table 10, a correspondence between a drowning identifier determining time and a drowning identifier may be stored in a corresponding database. The drowning identifier is determined once every 35 seconds. The drowning identifier is determined to be 0 at a 00th second, the drowning identifier is determined to be 1 at a 35^{th} second, and, by analogy, the drowning identifier is determined to be 1 at a 280th second. The drowning identifier is consecutively determined to be 1 from the 35^{th} second to the 280^{th} second, and an in-between time interval is 245 seconds. Assuming that preset drowning duration is 240 seconds, 245 seconds is greater than 240 seconds and an alarm is emitted. The drowning identifier is consecutively determined to be 1 from the 35th second to a 245th second, and an in-between time interval is 210 seconds, less than 240 seconds; therefore, no alarm is emitted, and only a prompt signal used to inform that the to-be-located object is at a potentially dangerous location is emitted. The preset drowning duration is determined according to prime rescue duration for drowning. Generally, the prime rescue duration is 240 seconds.

TABLE 10

| | Time for determining a drowning identifier (second) | | | | | | | | |
|---|---|---|---|---|---|---|---|---|---|
| | 00 | 35 | 70 | 105 | 140 | 175 | 210 | 245 | 280 |
| Drowning identifier | 0 | 1 | 1 | 1 | 1 | 1 | 1 | 1 | 1 |

Optionally, the first wearable device 702 is further configured to:

determine an RSSI value of a received electrical signal emitted by a second wearable device;

determine a distance between the first wearable device 702 and the second wearable device according to the RSSI value of the received electrical signal emitted by the second wearable device; and

after determining that the distance between the first wearable device 702 and the second wearable device is greater than a preset dangerous distance, emit a rescue prompt signal.

FIG. 11 is used as an example for detailed description. Assuming that objects carrying the first wearable device 702 and a second wearable device 704 are users, the first wearable device 702 receives an electrical signal emitted by the second wearable device 704. The first wearable device 702 determines an RSSI value of the received electrical signal according to the received electrical signal, and obtains, through calculation, a distance D1 between the first wearable device 702 and the second wearable device 704 by using the formula (1). If D1 is greater than the preset dangerous distance, it is indicated that the user carrying the second wearable device 704 is in a dangerous state, and the first wearable device 702 emits a rescue signal used to instruct the user carrying the first wearable device to perform rescue.

The preset dangerous distance is pre-configured in the first wearable device 702 according to an actual requirement.

Based on a same inventive concept, an embodiment of the present invention further provides a method for determining a location of an in-water object. A system corresponding to the method for determining a location of an in-water object in this embodiment of the present invention is the system for determining a location of an in-water object. Therefore, for implementation of the method in this embodiment of the present invention, reference may be made to the implementation of the system. Details are not repeated herein.

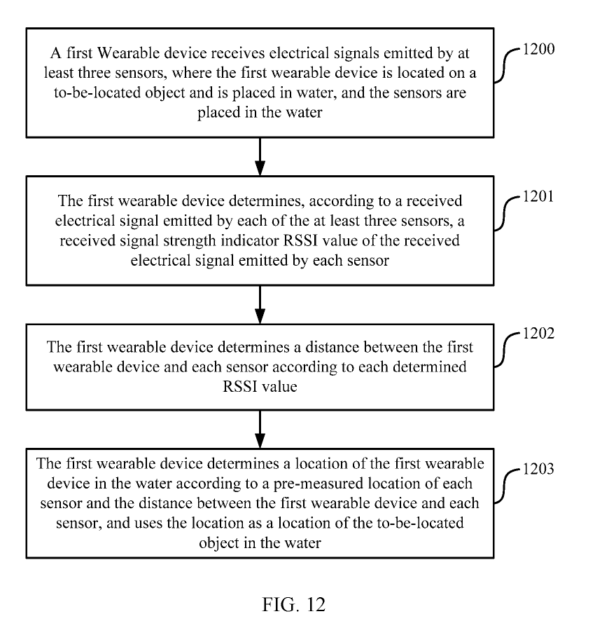

As shown in FIG. 12, a method for determining a location of an in-water object in an embodiment of the present invention includes the following steps.

Step 1200. A first wearable device receives electrical signals emitted by at least three sensors, where the first wearable device is located on a to-be-located object and is placed in water, and the sensors are placed in the water.

Step 1021. The first wearable device determines, according to a received electrical signal emitted by each of the at least three sensors, a received signal strength indicator RSSI value of the received electrical signal emitted by each sensor.

Step 1202. The first wearable device determines a distance between the first wearable device and each sensor according to each determined RSSI value.

Step 1203. The first wearable device determines a location of the first wearable device in the water according to a pre-measured location of each sensor and the distance between the first wearable device and each sensor, and uses the location as a location of the to-be-located object in the water.

Optionally, the first wearable device receives, at intervals of preset time, electrical signals emitted by the at least three sensors.

Optionally, after the determining, by the first wearable device, a location of the first wearable device in the water, the method further includes:

determining, by the first wearable device, a distance between the first wearable device and a surface of the water according to the determined location;

after determining that the distance between the first wearable device and the surface of the water is greater than a preset drowning height, increasing, by the first wearable device, a quantity of consecutive set-to-1 drowning identifiers by 1; and

if determining that the quantity of consecutive set-to-1 drowning identifiers is greater than a preset quantity, emitting, by the first wearable device, an alarm signal used to inform that the to-be-located object is at a dangerous location.

Optionally, the method further includes:

if determining that the quantity of consecutive set-to-1 drowning identifiers is not greater than the preset quantity, storing, by the first wearable device, a current drowning identifier as 1 in a preset database; and emitting a prompt signal used to inform that the to-be-located object is at a potentially dangerous location.

Optionally, the method further includes:

receiving, by the first wearable device, an electrical signal emitted by a second wearable device;

determining, by the first wearable device according to the received electrical signal emitted by the second wearable device, an RSSI value of the received electrical signal emitted by the second wearable device;

determining, by the first wearable device, a distance between the first wearable device and the second wearable device according to the determined RSSI value of the received electrical signal emitted by the second wearable device; and

after determining that the distance between the first wearable device and the second wearable device is greater than a preset dangerous distance, emitting, by the first wearable device, a rescue prompt signal.

Based on a same inventive concept, an embodiment of the present invention further provides a wearable device for determining a location of an in-water object. A system corresponding to the wearable device for determining a location of an in-water object in this embodiment of the present invention is the system for determining a location of an in-water object. Therefore, for implementation of the wearable device in this embodiment of the present invention, reference may be made to the implementation of the system. Details are not repeated herein.

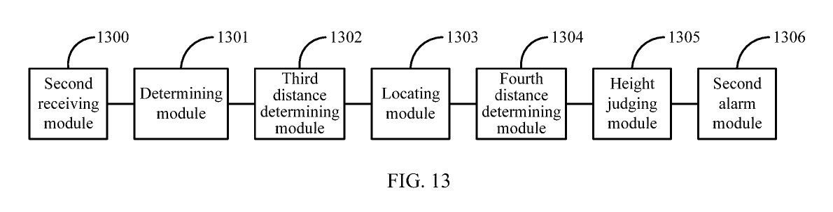

As shown in FIG. 13, a wearable device for determining a location of an in-water object in an embodiment of the present invention includes:

a second receiving module 1300, configured to receive electrical signals emitted by at least three sensors, where the wearable device is located on a to-be-located object and is placed in water, and the sensors are placed in the water;

a determining module 1301, configured to determine, according to a received electrical signal emitted by each of the at least three sensors, a received signal strength indicator RSSI value of the received electrical signal emitted by each sensor;

a third distance determining module 1302, configured to determine a distance between the wearable device and each sensor according to each determined RSSI value; and

a locating module 1303, configured to: determine a location of the wearable device in the water according to a pre-measured location of each sensor and the distance between the wearable device and each sensor, and use the location as a location of the to-be-located object.

Optionally, the first receiving module receives, at intervals of preset time, the RSSI values sent by the at least three sensors.

Optionally, the wearable device further includes:

a fourth distance determining module 1304, configured to determine a distance between the wearable device and a surface of the water according to the determined location of the wearable device in the water;

a height judging module 1305, configured to: after determining that the distance between the wearable device and the surface of the water is greater than a preset drowning height, increase a quantity of consecutive set-to-1 drowning identifiers by 1; and

a second alarm module 1306, configured to: if determining that the quantity of consecutive set-to-1 drowning identifiers is greater than a preset quantity, emit an alarm signal used to inform that the to-be-located object is at a dangerous location.

Optionally, the second alarm module 1306 is further configured to: if determining that the quantity of consecutive set-to-1 drowning identifiers is not greater than the preset quantity, store a current drowning identifier as 1 in a preset database, and emit a prompt signal used to inform that the to-be-located object is at a potentially dangerous location.

Optionally, the second receiving module 1300 is further configured to:

receive an electrical signal emitted by a second wearable device.

The determining module 1301 is further configured to:

determine, according to the received electrical signal emitted by the second wearable device, an RSSI value of the received electrical signal emitted by the second wearable device.

The third distance determining module 1302 is further configured to:

determine a distance between the wearable device and the second wearable device according to the determined RSSI value of the received electrical signal emitted by the second wearable device.

The second alarm module 1306 is further configured to:

after determining that the distance between the wearable device and the second wearable device is greater than a preset dangerous distance, emit a rescue prompt signal.

In this embodiment of the present invention, the module division is an example, and is merely logical function division. The module division may be another division manner in actual implementation. In addition, the functional modules in this embodiment of this application may be integrated into one processing module, or each of the modules may exist alone physically, or two or more modules may be integrated into one module. The integrated module may be implemented in a form of hardware, or may be implemented in a form of a software functional module.

When the integrated unit is implemented in a form of hardware, physical hardware, corresponding to the second receiving module 1300, of the wearable device is a transceiver. Physical hardware, corresponding to the determining module 1301, the third distance determining module 1302, the locating module 1303, the fourth distance determining module 1304, and the height judging module 1305, of the wearable device is a processor. Physical hardware, corresponding to the second alarm module 1306, of the wearable device is a sounder such as a speaker.

It can be learned from the foregoing content that the system for determining a location of an in-water object in the embodiments of the present invention includes the wearable device, the at least three sensors, and the processor. The wearable device is located on the to-be-located object, the to-be-located object is placed in the water, and the wearable device is configured to emit an electrical signal. Each sensor is placed in the water, and is configured to: determine the received signal strength indicator RSSI value of the received electrical signal emitted by the wearable device, and send the determined RSSI value to the processor. The processor is located on ground, and is configured to: determine, according to the RSSI value sent by each sensor, the distance between the sensor that sends the RSSI value and the wearable device, determine the location of the wearable device in the water according to the pre-measured location of the sensor and the determined distance between the sensor and the wearable device, and use the location as the location of the to-be-located object in the water. According to this technical solution, the location of the to-be-located object in the water is determined by using the RSSI value of the electrical signal. Therefore, determining a location of an in-water object is less affected by environmental and human factors, and reliability of determining the location of the in-water object is improved.

A person skilled in the art should understand that the embodiments of the present invention may be provided as a method, an apparatus (a device), or a computer program product. Therefore, the present invention may use a form of hardware only embodiments, software only embodiments, or embodiments with a combination of software and hardware. Moreover, the present invention may use a form of a computer program product that is implemented on one or more computer-usable storage media (including but not limited to a disk memory, a compact disc read-only memory, an optical memory, or the like) that include computer-usable program code.

The present invention is described with reference to the flowcharts and/or block diagrams of the method, the apparatus (device), and the computer program product according to the embodiments of the present invention. It should be understood that computer program instructions may be used to implement each process and/or each block in the flowcharts and/or the block diagrams, or a combination of a process and/or a block in the flowcharts and/or the block diagrams. These computer program instructions may be provided for a processor of a general-purpose computer, a dedicated computer, an embedded processor, or another programmable data processing device to generate a machine, so that the instructions executed by the processor of the computer or the another programmable data processing device generate an apparatus for implementing a specific function in one or more processes in the flowcharts and/or in one or more blocks in the block diagrams.

These computer program instructions may also be stored in a computer readable memory that can instruct a computer or another programmable data processing device to work in a specific manner, so that the instructions stored in the computer readable memory generate an artifact that includes an instruction apparatus. The instruction apparatus implements a specific function in one or more processes in the flowcharts and/or in one or more blocks in the block diagrams.

These computer program instructions may also be loaded onto a computer or another programmable data processing device, so that a series of operations and steps are performed by the computer or the another programmable device, thereby generating computer-implemented processing. Therefore, the instructions executed by the computer or the another programmable device provide steps for implementing a specific function in one or more processes in the flowcharts and/or in one or more blocks in the block diagrams.

Although some preferred embodiments of the present invention have been described, a person skilled in the art can make changes and modifications to these embodiments once they learn the basic inventive concept. Therefore, the following claims are intended to be construed as to cover the preferred embodiments and all changes and modifications that fall within the scope of the present invention.

Obviously, a person skilled in the art can make various modifications and variations to the present invention without departing from the spirit and scope of the present invention. The present invention is intended to cover these modifications and variations provided that they fall within the scope of protection defined by the following claims and their equivalent technologies.

What is claimed is:

1-4. (canceled)

5. A system for determining a location of an in-water object, comprising a first wearable device and at least three sensors, wherein
each of the at least three sensors is placed in water, and is configured to emit an electrical signal; and
the first wearable device is located on a to-be-located object, the to-be-located object is placed in the water, and the first wearable device is configured to:
separately determine received signal strength indicator (RSSI) values of received electrical signals emitted by the at least three sensors;
determine a distance between the first wearable device and each of the at least three sensors according to the determined RSSI value of received electrical signals emitted by the respective sensor;
determine a location of the first wearable device in the water according to a pre-measured location of each of the at least three sensors and the determined distance between the first wearable device and the respective sensor; and
use the location as a location of the to-be-located object in the water.

6. The system according to claim 5, wherein each of the at least three sensors emits an electrical signal at intervals of preset duration.

7. The system according to claim 6, wherein the first wearable device is further configured to:
determine a distance between the first wearable device and a surface of the water according to the determined location;
after determining that the distance between the first wearable device and the surface of the water is greater than a preset drowning height, increase a quantity of consecutive set-to-1 drowning identifiers by 1; and
if the quantity of consecutive set-to-1 drowning identifiers is determined to be greater than a preset quantity, emit an alarm signal to inform that the to-be-located object is at a dangerous location.

8. The system according to claim 7, wherein the first wearable device is further configured to:
if the quantity of consecutive set-to-1 drowning identifiers is determined to be not greater than the preset quantity, store a current drowning identifier as 1 in a preset database, and emit a prompt signal to inform that the to-be-located object is at a potentially dangerous location.

9. The system according to claim 5, wherein the first wearable device is further configured to:
determine an RSSI value of a received electrical signal emitted by a second wearable device;
determine a distance between the first wearable device and the second wearable device according to the RSSI value of the received electrical signal emitted by the second wearable device; and
after determining that the distance between the first wearable device and the second wearable device is greater than a preset dangerous distance, emit a rescue prompt signal.

10-13. (canceled)

14. A method for determining a location of an in-water object, comprising:
receiving, by a first wearable device, electrical signals emitted by at least three sensors, wherein the first wearable device is located on a to-be-located object and is placed in water, and the at least three sensors are placed in the water;
determining, by the first wearable device according to a received electrical signal emitted by each of the at least three sensors, a received signal strength indicator (RSSI) value of the received electrical signal emitted by the respective sensor;
determining, by the first wearable device, a distance between the first wearable device and each of the at least three sensors according to the respective determined RSSI value;
determining, by the first wearable device, a location of the first wearable device in the water according to a pre-measured location of each of the at least three sensors and the distance between the first wearable device and the respective sensor; and
using the location as a location of the to-be-located object in the water.

15. The method according to claim 14, wherein the first wearable device receives, at intervals of preset time, electrical signals emitted by the at least three sensors.

16. The method according to claim 15, wherein after the determining, by the first wearable device, a location of the first wearable device in the water, the method further comprises:
determining, by the first wearable device, a distance between the first wearable device and a surface of the water according to the determined location;
after determining that the distance between the first wearable device and the surface of the water is greater than a preset drowning height, increasing, by the first wearable device, a quantity of consecutive set-to-1 drowning identifiers by 1; and
if the quantity of consecutive set-to-1 drowning identifiers is determined to be greater than a preset quantity, emitting, by the first wearable device, an alarm signal to inform that the to-be-located object is at a dangerous location.

17. The method according to claim 16, wherein the method further comprises:
if the quantity of consecutive set-to-1 drowning identifiers is determined to be not greater than the preset quantity, storing, by the first wearable device, a current drowning identifier as 1 in a preset database; and emitting a prompt signal to inform that the to-be-located object is at a potentially dangerous location.

18. The method according to claim 14, further comprising:
receiving, by the first wearable device, an electrical signal emitted by a second wearable device;
determining, by the first wearable device according to the received electrical signal emitted by the second wearable device, an RSSI value of the received electrical signal emitted by the second wearable device;
determining, by the first wearable device, a distance between the first wearable device and the second wearable device according to the determined RSSI value of the received electrical signal emitted by the second wearable device; and
after determining that the distance between the first wearable device and the second wearable device is greater than a preset dangerous distance, emitting, by the first wearable device, a rescue prompt signal.

19-22. (canceled)

23. A wearable device for determining a location of an in-water object, comprising:
a second receiver, configured to receive electrical signals emitted by at least three sensors, wherein the wearable device is located on a to-be-located object and is placed in water, and the at least three sensors are placed in the water;
a non-transitory memory storage comprising instructions; and
one or more hardware processors in communication with the memory storage, wherein the one or more hardware processors execute the instructions to:
determine, according to a received electrical signal emitted by each of the at least three sensors, a received signal strength indicator (RSSI) value of the received electrical signal emitted by each of the at least three sensors;
determine a distance between the wearable device and each of the at least three sensors according to the respective determined RSSI value;
determine a location of the wearable device in the water according to a pre-measured location of each of the at least three sensors and the distance between the wearable device and the respective sensor; and
use the location as a location of the to-be-located object.

24. The wearable device according to claim 23, wherein the second receiver receives, at intervals of preset time, electrical signals emitted by the at least three sensors.

25. The wearable device according to claim 24, wherein the one or more hardware processors further execute the instructions to:
determine a distance between the wearable device and a surface of the water according to the determined location of the wearable device in the water;
after determining that the distance between the wearable device and the surface of the water is greater than a preset drowning height, increase a quantity of consecutive set-to-1 drowning identifiers by 1; and
if the quantity of consecutive set-to-1 drowning identifiers is determined to be greater than a preset quantity, emit an alarm signal to inform that the to-be-located object is at a dangerous location.

26. The wearable device according to claim 25, wherein the one or more hardware processors further execute the instructions to: if the quantity of consecutive set-to-1 drowning identifiers is determined to be not greater than the preset quantity, store a current drowning identifier as 1 in a preset database; and emit a prompt signal to inform that the to-be-located object is at a potentially dangerous location.

27. The wearable device according to claim 23, wherein the one or more hardware processors further execute the instructions to:
receive an electrical signal emitted by a second wearable device;
determine, according to the received electrical signal emitted by the second wearable device, an RSSI value of the received electrical signal emitted by the second wearable device;
determine a distance between the wearable device and the second wearable device according to the determined RSSI value of the received electrical signal emitted by the second wearable device; and
after determining that the distance between the wearable device and the second wearable device is greater than a preset dangerous distance, emit a rescue prompt signal.

28. The system according to claim 6, wherein the first wearable device is further configured to:
determine an RSSI value of a received electrical signal emitted by a second wearable device;
determine a distance between the first wearable device and the second wearable device according to the RSSI value of the received electrical signal emitted by the second wearable device; and
after determining that the distance between the first wearable device and the second wearable device is greater than a preset dangerous distance, emit a rescue prompt signal.

29. The system according to claim 7, wherein the first wearable device is further configured to:
determine an RSSI value of a received electrical signal emitted by a second wearable device;
determine a distance between the first wearable device and the second wearable device according to the RSSI value of the received electrical signal emitted by the second wearable device; and
after determining that the distance between the first wearable device and the second wearable device is greater than a preset dangerous distance, emit a rescue prompt signal.

30. The method according to claim 15, further comprising:
receiving, by the first wearable device, an electrical signal emitted by a second wearable device;
determining, by the first wearable device according to the received electrical signal emitted by the second wearable device, an RSSI value of the received electrical signal emitted by the second wearable device;
determining, by the first wearable device, a distance between the first wearable device and the second wearable device according to the determined RSSI value of the received electrical signal emitted by the second wearable device; and
after determining that the distance between the first wearable device and the second wearable device is greater than a preset dangerous distance, emitting, by the first wearable device, a rescue prompt signal.

31. The wearable device according to claim 24, wherein the one or more hardware processors further execute the instructions to:
receive an electrical signal emitted by a second wearable device;
determine, according to the received electrical signal emitted by the second wearable device, an RSSI value of the received electrical signal emitted by the second wearable device;
determine a distance between the wearable device and the second wearable device according to the determined RSSI value of the received electrical signal emitted by the second wearable device; and
after determining that the distance between the wearable device and the second wearable device is greater than a preset dangerous distance, emit a rescue prompt signal.

32. The wearable device according to claim 25, wherein the one or more hardware processors further execute the instructions to:
receive an electrical signal emitted by a second wearable device;
determine, according to the received electrical signal emitted by the second wearable device, an RSSI value of the received electrical signal emitted by the second wearable device;
determine a distance between the wearable device and the second wearable device according to the determined RSSI value of the received electrical signal emitted by the second wearable device; and
after determining that the distance between the wearable device and the second wearable device is greater than a preset dangerous distance, emit a rescue prompt signal.
